(19) United States
(12) Patent Application Publication
(10) Pub. No.: US 2018/0033280 A1
(43) Pub. Date: Feb. 1, 2018

(54) METHOD AND SYSTEM TO AWAKEN A DROWSY DRIVER

(71) Applicant: Wheego Electric Cars, Inc., Atlanta, GA (US)

(72) Inventor: Thomas Steven Taylor, Atlanta, GA (US)

(21) Appl. No.: 15/653,387

(22) Filed: Jul. 18, 2017

Related U.S. Application Data
(60) Provisional application No. 62/367,208, filed on Jul. 27, 2016.

(51) Int. Cl. G08B 21/06; B60R 16/02; B60R 16/08; G06K 9/00; B05B 12/12

(52) U.S. Cl. CPC G08B 21/06; G06K 9/00255; G06K 9/00288; G06K 9/00845; B05B 12/12; B60R 16/08; B60R 16/02; B05B 1/005

(57) ABSTRACT

A puffer device receives a puffer trigger instruction signal from a computer device that processes signals generated by one or more sensors associated with a vehicle, such sensors including cameras focused on a drivers face or head, cameras directed at lane markers, or motion sensors that may be worn by the driver or included in an article worn by the driver. When the computer device determines that a danger condition has occurred, such as the driver being drowsy or veering out of a travel lane, the puffer device orients itself based on the detected location of the driver's head and puffs air at the drivers head or face to alert or awaken him or her. The puffer trigger instruction signal may include instructions to direct additional puffs, possibly of different velocity, length, or frequency, at the driver if the danger condition, or conditions, continue to exist after a first puff.

### CROSS REFERENCE TO RELATED APPLICATION

This application claims priority under 35 U.S.C. §119(e) to U.S. Provisional patent application 62/367,208 entitled “Method and system to awaken a drowsy driver,” which was filed Jul. 27, 2016, and which is incorporated by reference herein in its entirety.

### FIELD

Techniques operate on a trigger to alert and awaken a driver that exhibits characteristics of sleeping, getting drowsy, or other dangerous driving condition.

### BACKGROUND

As computing processing power grows and is used in automobiles to take over more and more conventional operator functions, drivers and passengers more and more rely on systems to automatically pilot the automobile by detecting proximity to another vehicle, and immovable objects, or the veering of the moving automobile from a given lane.

### SUMMARY

A puffer device comprises a puffer discharge port and a puffer discharge portion, that may be a tube-shaped portion, and that defines the puffer discharge port at a distal end of the puffer discharge portion. A puffer air receiver receives air from an air source at a receiving end and the puffer air receiver directs air from the air source into a proximate end of the puffer discharge portion. An air valve regulates air flow from the air source into the proximate end of the puffer discharge portion and a movable mount that permits, or facilitates, changeable orientation, which may change relative to a vehicle cabin or relative to a user's head orientation, of the puffer discharge port according to instructions included in a puffer trigger instruction signal. The air valve may be a butterfly valve, a gate valve, a globe valve or a sluice-gate type valve and may be operated by instructions included in a puffer trigger instruction signal. The movable mount may include a gimbal system, including a motorized gimbal system that, permits, and may be moved by motors of the motorized system, to change orientation of the puffer device in one or more dimensions, including one, two, or three dimension gimbal mounting systems. The movable mounting system may also include one or more extension arm(s) that can extend or retract the puffer device parallel to one or more of the rotation axes of the movable mounting system.

A computer device includes a processor that may be configured to receive a sensor signal from a sensor that detects one or more parameters associated with operating an automobile. The processor may process the sensor signal to determine from the one or more parameters that a danger condition has occurred. The processor of the computer device may generate a puffer trigger instruction signal based on the determination that the danger condition has occurred, or is likely to occur, and the processor may transmit the puffer trigger instruction signal to a puffer device. The puffer trigger instruction signal may include one or more orientation instructions to the movable mounting system for causing the puffer device to achieve a particular orientation and to discharge air according to discharge instructions.

### BRIEF DESCRIPTION OF THE DRAWINGS

FIG. 1 illustrates a vehicle cockpit showing locations of a puffer device and driver's head camera/sensor.

FIG. 2 illustrates details of a puffer device.

FIG. 3 illustrates a flow diagram of a method for causing a puffer device to alert a driver of a danger condition.

### DETAILED DESCRIPTION

As a preliminary matter, it will be readily understood by those persons skilled in the art that the present invention is susceptible of broad utility and application. Many methods, aspects, embodiments, and adaptations of the present invention other than those herein described, as well as many variations, modifications, and equivalent arrangements, will be apparent from, or reasonably suggested by, the substance or scope of the present invention.

Accordingly, while the present invention has been described herein in detail in relation to preferred embodiments and aspects, it is to be understood that this disclosure is only illustrative and exemplary of the present invention and is made merely for the purposes of providing a full and enabling disclosure of the invention. The following disclosure is not intended nor is to be construed to limit the present invention or otherwise exclude any such other embodiments, adaptations, variations, modifications and equivalent arrangements, the present invention being limited only by the claims appended hereto and the equivalents thereof.

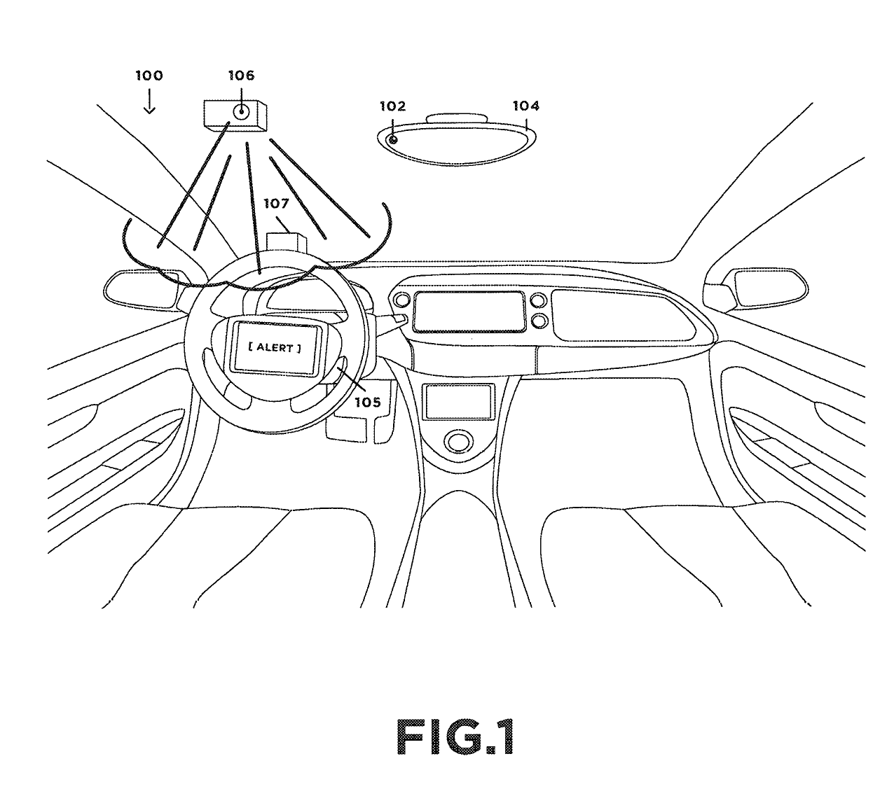

A sensor, such as a camera, capable or capturing still images as well as video content, or computer devices in communication therewith, may perform image recognition, or apply image processing techniques, to determine that a driver is falling asleep, that the driver is very inattentive, that the driver has totally fallen asleep, or that some other danger condition has occurred such as the vehicle veering out of a travel lane. If the sensor is not a camera and only provides parameter information; such as wearable sensors that detect motion or sensors that measures distance, temperature, or sound; instead of image recognition or image processing, the computer device may only determine that a driver's head has moved its general position relative to the sensor to determine that the driver has fallen asleep or is getting drowsy. FIG. 1 illustrates a cockpit view of the interior 100 of a vehicle. Camera 102 may be fixed with a bracket to a portion of the automobile such that when a processor of the computer device performing image recognition, or facial recognition, may determine that the driver's face has gradually moved to a lower portion of an image frame as compared to the location, or portion, of a similar image frame captured from the camera at an earlier time. In an aspect, image, or video, processing software may determine that a driver has become sleepy by analyzing movement of the driver's head, or face, in a manner that has been predetermined to indicate drowsiness, such as, for example, the head slowly moving down in the frame of the camera capturing images of the drivers face, followed by a quick upward jerking movement of the head, or that the driver's eyes are closed. In the figure, camera 102 may be mounted to rear-view mirror 104, although the camera may be mounted in other places or attached to other portions in interior 100, such as location 105 on the steering wheel or location 107 on top of the dashboard. In addition, camera 102 may even be part of a user's smart phone which transmits images, video, or drowsy-driver determinations over a short range wireless link to a wake-up/alerting device, or to a computer in communication therewith. It will be appreciated that the puffer device 106 and camera 102 may each be mounted at any of the locations described above, or at any other location deemed appropriate based on engineering, safety, or regulatory constraints. In addition, camera 102 and puffer device 106 may be collocated at a given location, and may be included in the same device.

The computer device, that may be coupled to camera 102, or at least arranged to receive communication signals and messages that are generated by, or derived from the images captured by, the camera, generates a puffer trigger signal in response to a determination that an image, or images, captured by the camera, indicate that the driver is drowsy, or has fallen asleep. The computer device may be part of a vehicle computer system, such as an ECM, an entertainment head unit, a telematics control unit, or may be part of a user's smart phone or tablet device. Camera device 102 itself may include the computer device, or the equivalent of the computer device, that performs the image or facial recognition processing. Or, a computer device separate from the camera may perform the processing. Upon determining that images captured by the camera indicate that the driver has become drowsy, the computer processing device may generate the puffer trigger signal that is forwarded to puffer device 106.

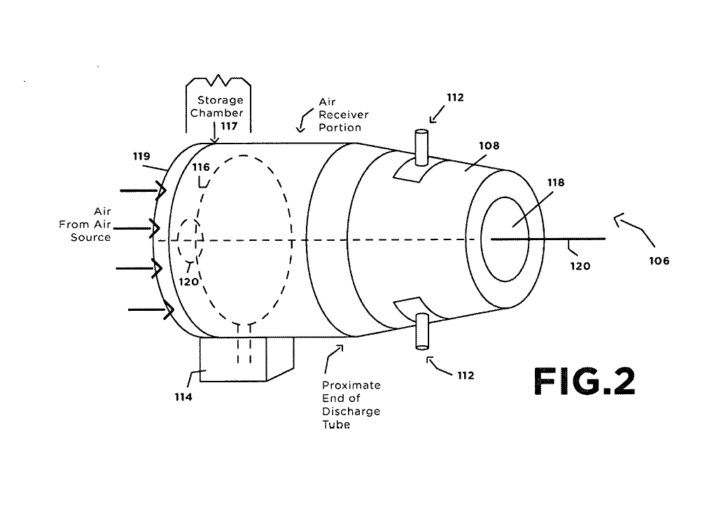

As shown in FIG. 2, puffer device 106 may comprise a nozzle 108, a portion for receiving air from a compressed air source, an air valve 110, and electronic control circuitry (not shown in the figure) that operates in response to the puffer trigger signal. The air source may include a small air compressor with a storage tank that may be part of puffer device 106, or may be separate from the puffer device and may deliver compressed air to the puffer device. Puffer device 106 may include mounting pins for mounting the puffer device to the vehicle with a gimbal, which may be a single, double, or triple gimbal device, or may include even more gimbals to permit a wide range of orientation of the puffer's nozzle. The gimbal mount may even include one or more telescoping extend/retract arms that facilitate even more orientation and placement options of the nozzle's discharge port. The gimbal may be motorized and mounted via a platform to the vehicle's interior 100, as shown in FIG. 1. In response to the puffer trigger signal, which may include orientation and location information of the driver's face or head relative to an orientation and location of the driver's face or head in a reference position or reference image, puffer 106 may be moved by a movement means (i.e., a motorized gimbal mount, motorized arms that can cause orientation and location changes of the puffer when mounted to a passive gimbal, or telescoping brackets or mounting arms) such that puffer nozzle 108, which may also be referred to herein as a puffer discharge portion, or puffer discharge tube, shown in FIG. 2 is aimed at a predetermined area of the drivers face, or other part of the driver's body. After the puffer has been oriented in relation to the driver's face or head, the computer circuitry may send a control signal to a movement means 114, such as a motor, solenoid, spring latch release, etc., coupled to air valve 116 instructing it to open for a predetermined puff period, or predetermined puff periods, so that nozzle 108 emits a puff, or puffs, of air directed at the predetermined area of the drivers face, head, or other body part. It will be appreciated that even if puffer device 106 receives air from a separate compressor, the puffer device may also have an air storage portion 117, or chamber, for storing air so that when air valve 116 opens, air deliver does not rely on whether a separate compressor has attained a given pressure needed for generating a puff from the puffer device. Air storage portion 117 may be a portion of puffer device 106 between an air inlet 119 and air valve 116, and the air inlet may include a check valve, such as check ball 120 shown in the figure. It will also be appreciated that instead of a movable mount, puffer device 106 may be mounted with an unmovable mount fixed to the interior or vehicle interior 100 and pointed generally in the direction of a driver's head.

Air valve 116 may comprise an open/close valve, or may comprise a variable aperture that can change in response to the puff trigger signal such that the puff has a higher velocity when the aperture is small, or a lower velocity when the aperture is larger. The aperture may be located inside puffer device 106 behind the nozzle 108, which may have a fixed-size discharge port 118. Or, nozzle discharge port 118 may comprise a variable port size (i.e., a variable aperture), which may vary all the say from a zero radius (closed) to a predetermined maximum port radius (open). In an aspect shown in the figure, nozzle 108 may be a discharge tube having a varying cross sectional area, i.e., when the discharge tube is viewed in a side view, the discharge tube tapers toward discharge port 118 from a larger radius to a smaller radius. In another aspect, the slope of the taper, i.e., the change in radius with respect to the length of discharge tube 108, may be variable (i.e., tube 108 may shortened or lengthened along puffer device axis 120). In yet another aspect, discharge tube portion 108 of device 106 may be made from a flexible, or non-rigid, material such that the shape of discharge port 118 may vary to create a varying puff discharge quality in response to a port shape command included in the puff trigger signal.

The computer device may vary the puff trigger signal according to a response of the driver. For example, a first puff trigger signal may first instruct the puffer to direct a mild puff at the driver's head after a determination has been made that the driver is drowsy. If the facial, or image, recognition software processed by the computer device does not detect a predetermined head, or face, position of the driver indicating an alert driver after a first puff, a second puff trigger signal may instruct the puffer motorized mounting system to move the discharge port closer to the driver's head, or instruct the motorized mounting system to orient the discharge port at a particular portion of the driver's face for delivery of a second puff. In addition, the second puff signal may direct the puffer to configure the nozzle discharge and discharge port size such that the second puff is a stronger, or higher velocity, puff than the previous puff. In an aspect, the duration may be varied from the first puff to the second, and from the second to the third, and from the third to a forth, etc. In an aspect, the air source may deliver scented air, or a scent may be injected into the puffer device to scent the puff that may be discharged from discharge port 118.

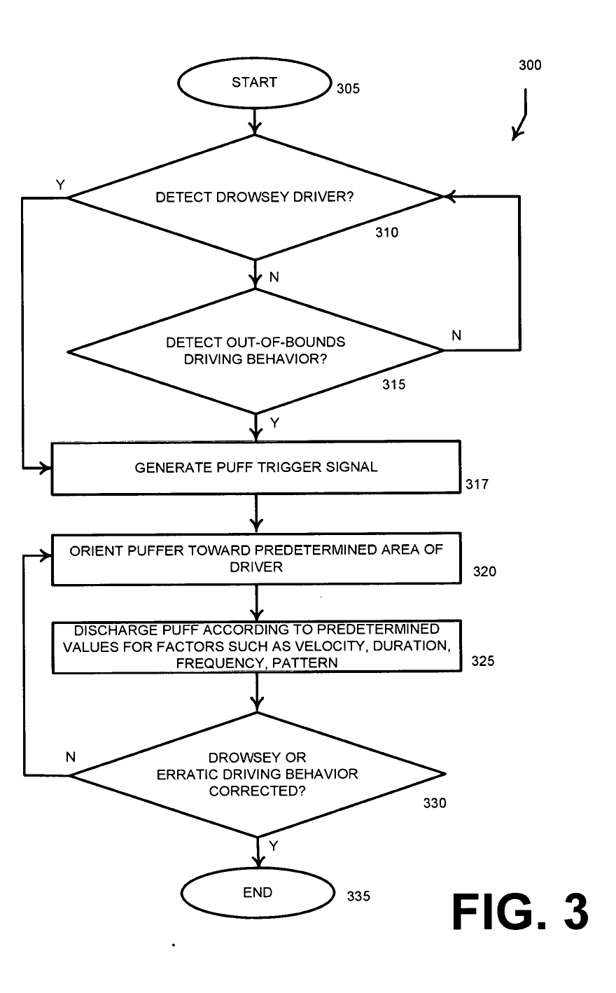

Turning now to FIG. 3, a flow diagram illustrates steps of a method 300 for alerting, or awakening, a drowsy driver. Method 300 begins at step 305. At step 310, computer instructions, either in camera 102, in a user's/driver's smart phone (not shown), or in another device separate from camera 102 or a smartphone, cause a processor of a computer device on which the instructions are running to process an image of a driver, or images of a driver, whether still or part of a video stream, to determine whether a driver is drowsy or has fallen asleep. Such determination may be made by analyzing the location of the driver's face or head within the image frame relative to the location where the drivers head or face should be if the drier were alert and paying attention to driving tasks. At step 315, the computer device that processes signals, messages, information, and data from camera 102 may process input signals from sensors other than the camera to determine whether the vehicle associated with cockpit interior 100 is within boundaries of the road the vehicle is driving on. Such boundaries may have tolerances associated with them to preclude false-positive determinations that a vehicle may have drifted outside a boundary. Such boundaries may include, for example, lane markings on a road, images of which may be captured from exterior (to the vehicle) cameras that are pointed in a direction that lane markings are typically found in relation to a vehicle that is traveling in the lane. The tolerance values may be predetermined fixed values, or may differ according conditions such as road type, lane width, lane marking width, or according to dynamic factors such as speed, time of day, location, previous location where vehicle was stationary for an extended period before the current drive, (i.e., an establishment hat serves alcoholic beverages), amount of daylight, number of surrounding vehicles as determined by sensors or cameras, or traffic information received from a traffic information provider. Much of the information used to analyze the conditions and dynamic factors that may causes modification of tolerances may be determined, retrieved, derived, or requested from a vehicle communication system component, such as a CAN bus, OBD-II port, serial port, Bluetooth-link from an entertainment head unit, or other vehicle communication device, or the conditions or dynamic factor information may be detected by and received from a smart phone. In addition, tolerances may be fine-tuned according to driver behavior acquired over a previous period such that occasional drifting in a lane by a given driver may be permitted after a learning algorithm may have determined from past drives by the driver that he, or she, tends to meander within a given travel lane without presenting a safety hazard to himself, herself, or other motorists. A given driver of a vehicle may be identified by driving characteristics, biometric information, input of user credentials, use of a given key or key fob, or other means. In an aspect, ‘looser’ tolerances may be more permissible for one driver (e.g., an adult) than for another driver (e.g., a teenage driver). If either steps 310 or 315 result in a determination that the driver is drowsy or has deviated from a travel lane, has attained excessively high or excessively low speed, is swerving, is varying the speed of the vehicle when a determination from a GPS device, or similar device, does not indicate corresponding changes in elevation, road curves, or other conditions such as road roughness or traffic control devices, then method 300 may proceed to step 317 at which time the computer device may generate a puffer trigger instruction signal and forward it to puffer device 106 as shown in FIGS. 1 and 2.

Continuing with the description of FIG. 3, it will be appreciated that steps 310 and 315 may be performed in differing order from the order shown in the figure, or may be performed in parallel with one another if multiple processors of the computer device process input signals from multiple sensors, cameras, or information feeds. The puffer trigger instruction signal may include instructions to orient the puffer device's, or devices' (an aspect may include more than one puffer device in cockpit 100) discharge port, or ports, toward the drowsy or inattentive driver. The puffer instruction signal may include instructions to cause motors or solenoids coupled to, or part of, the gimbal mounting system that mounts the puffer device to the vehicle cockpit 100, or motors or solenoids that operate arms coupled to the puffer device, to move the orientation of the puffer device at step 320 so that air discharged from the discharge port of the puffer is directed toward the face, or other predetermined portion of the driver's head or body, based on the location of the drivers head or body as determined by the image or facial recognition processing discussed above in connection with step 310. As discussed above, the puffer device may be fixed to cockpit 100 rather than mounted thereto via a movable mount or movable mounting system.

At step 325 the puffer may discharge a puff, or puffs, of air according to the puffer trigger instruction signal. For example, if a current iteration of step 325 is a first iteration since the generation of a puffer trigger instruction signal at step 317, then the puffer instruction signal may instruct the puffer to emit a low velocity, short puff of air at the drivers face or scalp area so as not to direct a high pressure blast of air at the drivers eyes. At step 330, the computer device determines whether the conditions that resulted in a determination at step 310 that the driver was drowsy or a determination at step 315 that the driver was operating the vehicle outside a set of predetermined boundaries still exist. If the determination is made at step 330 that one or more conditions that resulted in the generation of a puffer trigger instruction signal at step 317 no longer exist, then method 300 ends at step 335.

If, however, the computer device processor does not determine at step 330 that drowsy or erratic/out-of-bounds driving behavior has been corrected, the puffer trigger instruction signal generated at step 317 may have included instructions to orient the puffer for a subsequent puff at a different portion of the driver's body than during the first iteration of step 320, and may have included instructions to provide a higher velocity puff, or series of puffs/bursts of air, at a predetermined frequency, and at differing duration, or durations, with the same, or a potentially revised, orientation of the puffer. Alternatively, instead of a first puffer trigger information signal including instructions for orientation and puff characteristics for first, second, and subsequent iterations of steps 320, 325, and 330, after a first iteration of step 330 determines that the drowsy, erratic, or out-of-bounds driving has not been corrected, method 300 may return to step 317 for generation of a new/revised puffer trigger instruction signal that includes instructions for the next, and perhaps subsequent, iterations of steps 320, 325, and 330.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. Disclosure of particular hardware is given for purposes of example. Some steps recited in the method claims below may be performed in a different order than presented in the claims and still be with the scope of the recited claims.

What is claimed is:

1. A puffer device, comprising:
a puffer discharge port;
a puffer discharge portion that defines the puffer discharge port at a distal end of the puffer discharge portion;
a puffer air receiver for receiving air from an air source at a receiving end, wherein the puffer air receiver directs air from the air source into a proximate end of the puffer discharge portion
an air valve for regulating the flow of air from the air source into the proximate end of the puffer discharge portion; and
a movable mount that facilitates, changeable orientation of the puffer discharge port according to instructions included in a puffer trigger instruction signal.

2. The puffer device of claim 1 further comprising a motor for operating the air valve according to instructions included in the puffer trigger instruction signal.

3. The puffer device of claim 1 wherein the discharge portion is made of a flexible material.

4. The puffer device of claim 3 wherein the movable mount includes a extender/retractor arm that causes the discharge tube to change length along an axis of the puffer device according to instructions included in a puffer trigger instruction signal.

5. The puffer device of claim 1 wherein the movable mount is mounted to an interior cockpit and causes the achievement of an orientation of the puffer device according to instructions included in the puffer trigger instruction signal.

6. A method, comprising:
processing a sensor signal from a sensor that detects one or more parameters associated with operating an automobile;
determining from the processing of the one or more parameters that a danger condition has occurred;
generating a puffer trigger instruction signal based on the determining that the danger condition has occurred; and
forwarding the puffer trigger instruction signal to a puffer device, wherein the puffer trigger instruction signal includes one or more orientation instructions for causing the puffer device to achieve a particular orientation and to discharge air according to discharge instructions.

7. The method of claim 6 wherein the danger condition is determined based on an orientation of a driver's head relative to a reference orientation, wherein the driver is a driver of the automobile.

8. The method of claim 6 wherein the danger condition is determined based on a change in a facial recognition analysis compared to a reference facial recognition analysis, wherein the facial recognition analysis is generated according to processing by image recognition software of the sensor signal, wherein one of the one or more parameters is the open/close status of a driver's eyes, wherein the change results from a determination that a driver of the automobile has closed their eyes, wherein the sensor is a camera, and wherein the sensor signal is an image of the driver's face.

9. The method of claim 6 wherein the discharge instructions include instructions for the puffer device to discharge a low velocity puff for a first determination that the danger condition has occurred.

10. The method of claim 9 wherein the discharge instructions include instructions for the puffer device to discharge a subsequent puff having a higher velocity than a previous puff after a determination that the danger condition continues to exist subsequent to one or more previous puffs.

11. The method of claim 6 wherein the discharge instructions include instructions for the puffer device to discharge a low velocity puff having a first duration for a first determination that the danger condition has occurred.

12. The method of claim 11 wherein the discharge instructions include instructions for the puffer device to discharge multiple subsequent puffs each having a shorter duration than the first duration after a determination that the danger condition continues to exist subsequent one or more previous puffs.

13. The method of claim 6 wherein the sensor is a camera, and wherein the sensor signal is an image of the driver's face.

14. A computer device, comprising:
a processor to:
receive a sensor signal from a sensor that detects one or more parameters associated with operating an automobile;
process the sensor signal to determine from the one or more parameters that a danger condition has occurred;
generate a puffer trigger instruction signal based on the determination that the danger condition has occurred; and
transmit the puffer trigger instruction signal to a puffer device, wherein the puffer trigger instruction signal includes one or more orientation instructions for causing the puffer device to achieve a particular orientation and to discharge air according to discharge instructions.

15. The computer device of claim 14 wherein the danger condition is determined based on an orientation of a driver's head relative to a reference orientation, wherein the driver is a driver of the automobile.

16. The computer device of claim 14 wherein the danger condition is determined based on a change in a facial recognition analysis compared to a reference facial recognition analysis, wherein the facial recognition analysis is generated according to processing by image recognition software of the sensor signal, wherein one of the one or more parameters is the open/close status of a driver's eyes, wherein the change results from a determination that a driver of the automobile has closed their eyes, wherein the sensor is a camera, and wherein the sensor signal is an image of the driver's face.

17. The computer device of claim 14 wherein the one or more parameters includes a lane location distance of the automobile from a lane marker, and wherein the danger condition is determined to occur when the lane location distance exceeds a predetermined permissible lane location distance limit value.

18. The computer device of claim 17 wherein the permissible lane location distance limit value is a first permissible lane location distance limit value for a first driver and wherein the permissible lane location distance limit value is a second permissible lane location distance limit value for a second driver, wherein both first and second drivers are registered with the computer device as having authority to operate the automobile.

19. The computer device of claim 14 wherein the computer device is a smart phone, wherein the computer device includes the sensor, and wherein the computer device wirelessly transmits the puffer trigger instruction signal to the puffer device, which is separate from the computer device, and which is fixed to the automobile via a movable mounting system that can cause movement of the puffer device according to instructions in the puffer trigger instruction signal.

20. The computer device of claim 14 wherein the computer device is a smart phone, wherein the computer device includes the sensor, and wherein the computer device transmits the puffer trigger instruction signal to the puffer device, which is part of the computer device, and which includes a flexible discharge nozzle that can changes in orientation of a puff of the puffer device according to instructions in the puffer trigger instruction signal.
